(19) United States
(12) Patent Application Publication
(10) Pub. No.: US 2016/0309743 A1
(43) Pub. Date: Oct. 27, 2016

(54) PLANT BASED PROTEIN EXTRACTION METHOD AND SYSTEM

(71) Applicant: Nutriati, Inc., Richmond, VA (US)

(72) Inventors: Michael Spinelli, Moseley, VA (US); Krisan Singh, Midlothian, VA (US)

(21) Appl. No.: 14/694,341

(22) Filed: Apr. 23, 2015

(51) Int. Cl. A23J 1/14; A23P 1/02

(52) U.S. Cl. CPC A23J 1/14; A23P 1/02

(57) ABSTRACT

A system and method for generating a protein concentrate includes generating an initial alkalized slurry by combining flour, water and a base and generating a solubilized rich protein stream therefrom. The method and system includes generating a de-oiled solubilized rich protein stream by separating the solubilized protein rich stream and generating a protein precipitate including an acid curd by mixing the de-oiled solubilized rich protein stream with an acid and separating the acid curd from the protein precipitate. The system and method further includes washing the first protein curd using a wash station to generate a second protein curd, generating a neutral hydrolyzed protein slurry by mixing the second protein curd with a base and water and generating a homogenized protein slurry from the protein slurry. The method and system includes generating a cooled protein slurry by pasteurizing the homogenized protein slurry and extracting the protein concentrate therefrom.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The disclosed technology relates generally to processing plant-based food items for the extraction of protein and more specifically to a method and system for extracting protein, and other outputs, from chickpeas.

### BACKGROUND

Modern food processing trends provide for greater access to macronutrients naturally present in foods. With the growth of consumer demand for high quality food, there is a related growth for improved food processing techniques to extract high-quality macronutrients consistent with consumer beliefs.

For example, it is common for users to require food sources to be organic and composed of ingredients that are non-genetically modified (non-GMO). Another example are consumers seeking to avoid particular food sources, such as consuming a plant-based diet.

In addition to demand for food types being driving by consumer choice, such choices are additionally fueled by consumer intelligence to allergic or inflammatory responses. It is not uncommon for a person to an some adverse reaction to a food source, with severity of reaction differing widely between consumers.

Amongst the macronutrients, protein remains the quintessential macronutrient for the promotion of growth and health maintenance. While protein is readily available and commonly found in many food sources, extraction as a supplement for manufactured food sources can be problematic in seeking specialized solutions.

A common protein supplements from non-plant based sources is whey protein, usable as an example of the concerns of modern protein source manufacturing. The quality of the protein product is directly related to the quality of the original source of protein, thus problems can arise from the quality of the original source. Another problem is whey protein is unavailable to vegan and other non-plant-based consumers.

Another problem is that protein quality and other attendant factors are directly affected by the manufacturing/extraction process. One attendant factor can be the absorption factor of the protein by the user, whether the protein is a quickly-digestible/absorbing protein.

The most common form of plant-based protein is soy protein. While serving several market needs, there exists a need for a wider variety of protein-types and a greater degree of stability in the protein itself. For example, consumers can have allergies or other inflammatory responses from the protein source.

The chickpea is the only readily-available plant-based protein source lacking known consumer allergies. Chickpea protein has a long history a large degree of stability in food processing. Based on the dynamics of the chickpea itself, there is limited technology exists chickpea protein extraction. Existing techniques require heavily structured processes, including operations within very narrow ranges and convoluted processing steps.

As such, there exists a need for a method and system to efficiently extract high quality protein from chickpeas.

### BRIEF DESCRIPTION

A first mixer receives flour, water and a base. In one embodiment, the flour is a chickpea flour, but it is recognized that other suitable types of flour may be utilized, where various types of flour utilize varying processing operations for protein extraction, as noted herein. In this step, via the mixer, the flour is hydrated and there is a pH shift to solubilize the protein a solid-liquid extraction.

Based on the mixing operations, the mixer outputs an initial alkalized slurry. The initial alkalized slurry is then transported to a first separator. The first separator separates the initial alkalized slurry into a starch precipitate and a solubilized protein rich steam.

The solubilized protein rich stream is further processed to a second separator and separated to remove cream fraction. The centrifuge output includes a concentrated oil cream and a de-oiled solubilized protein rich stream. The concentrated oil cream may be discarded or otherwise processed. Whereas, the present processing system therein transfers the de-oiled solubilized protein rich stream to a second mixer. An acid is additionally added into the second mixer.

Within the second mixer, the combination of de-oiled solubilized protein rich stream and the acid generates a protein precipitate. In this second mixer tank, acid is added to iso-electrically precipitate the protein.

The combination in the second mixer generates the protein precipitate composed of a serum and an acid curd. The protein precipitate is provided to a third separator. In one embodiment, the protein precipitate is fed by a low-shear pump to third separator, being a decanter centrifuge, to separate the serum from the acid curd. The serum protein is extracted, leaving a first protein curd transferred to a wash station.

Within the wash station, water is added to acid curd to rehydrate the mixture. The wash station further includes wash separator that is, in one embodiment, fed by low-shear pump to the decanter centrifuge to separate the serum from the acid curd. The wash separator therein generates a second protein curd.

Once the process completes one or more washing operations, a third mixer receives the protein curd output, as well as a base, water and an enzymatic cocktail (protease).

The third mixer output is a neutral hydrolyzed protein slurry. A high pressure homogenizer receives the slurry such that high pressure homogenization provides for texture, particle size control, and homogenization of the slurry.

The high pressure homogenizer generates an output of a homogenized protein slurry. This homogenized protein slurry is then pasteurized using a pasteurizer.

The pasteurization generates a pasteurized protein slurry. This slurry is fed into a vacuum evaporator. In one embodiment, the vacuum evaporator's pressure, temperature and flow rate dependent on pasteurization setup of the pasteurizer.

Water is removed using the vacuum evaporator, producing an output of a cooled protein slurry. The cooled protein slurry is fed into a drier. The drier performs drying operations to generate the dried protein concentrate.

### BRIEF DESCRIPTION OF THE DRAWINGS

FIG. 1 illustrates a block diagram of one embodiment of a system for generating chickpea protein concentrate.

FIG. 2 illustrates one embodiment of a wash station of the system of FIG. 1.

FIG. 3 illustrates another embodiment of a wash station of the system of FIG. 1

FIG. 4 illustrates a flowchart of one embodiment of a method for generating chickpea concentrate.

FIG. 5 illustrates another embodiment of a portion of the system for generating chickpea protein concentrate of FIG. 1.

FIG. 6 illustrates steps of embodiment of the method for generating chickpea protein concentrate.

FIGS. 7a and 7b illustrate one exemplary embodiment of a system for generating chickpea protein concentrate.

A better understanding of the disclosed technology will be obtained from the following detailed description of the preferred embodiments taken in conjunction with the drawings and the attached claims.

### DETAILED DESCRIPTION

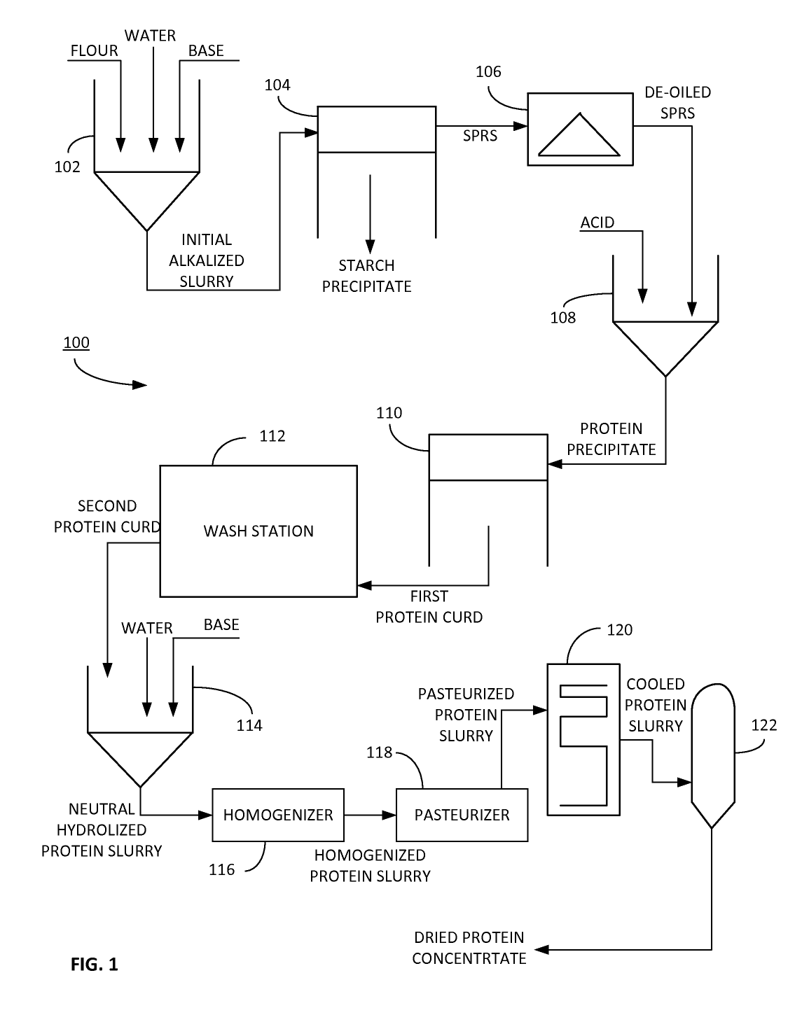

FIG. 1 illustrates a system 100 including a first mixer 102, a first separator 104, a second separator 106 and a second mixer 108. The system further includes a third separator 110, a wash station 112, a third mixer 114, a homogenizer 116, a pasteurizer 118, a vacuum evaporator 120 and a drier 122.

FIG. 1 illustrates one embodiment of a process flow operation for generating the chickpea concentrate as described herein. In this embodiment, the process described herein makes the product of a chickpea concentrate.

The first mixer 102 receives flour, water and a base. In one embodiment, the flour is a chickpea flour, but it is recognized that other suitable types of flour may be utilized. In this step, via the mixer, the flour is hydrated and there is a pH shift to solubilize the protein a solid-liquid extraction.

It is within the scope of the present invention that varying types of chickpea flour or the protein-based input ingredient(s) may be utilized, where the process described herein may be modified to account for such variations in the mixer 102 input. For example, the chick pea flour may be a de-oiled flour, such that further processing operations described below for performing de-oiling operations may be omitted. For example, the flour may be pre-treated with a hexane extraction process, or other process to modify or adjust the physical composition of the flour.

In one embodiment, in the mixer 102, hydration of the flour includes water ratio ranges between 5-12:1 depending on equipment and desired purity of end product. While varying ranges may be utilized, this embodiment includes a low-end ratio is found to be 4:1, with a high-end ratio dependent upon capacity of drying operations noted below. In one embodiment, operational temperature range is between 4-60 C depending on embodiment of final product attribute, including generating a pH between 8-11. The mixer 102, in this embodiment, operates using low shear conditions. Similarly, this embodiment uses a reaction time between 30-60 min depending on holding conditions.

It is noted that the above ranges and conditions, as well as ranges, conditions and values noted within the present specification, are exemplary in nature of the various embodiments. The ranges and conditions are not limiting of the disclosed invention, wherein operations aspects outside the noted ranges may be utilized in the protein extraction process, as recognized by one skilled in the art.

Based on the mixing operations, the mixer outputs an initial alkalized slurry. The initial alkalized slurry is then transported to the first separator 104. As described in further detail below, the initial alkalized slurry may be transported using a low sheer pump, but it is recognized that any suitable pump may be utilized.

The first separator 104 separates the initial alkalized slurry into a starch precipitate and a solubilized protein rich steam. The separator 104, in one embodiment, is a decanter centrifuge. The starch precipitate is extracted and in one embodiment can be discarded. The solubilized protein rich stream is further processed to a second separator 106.

In one embodiment, solubilized protein rich stream may be transferred to the separator 106 using a low-sheer pump, but any other suitable pump may be utilized.

The solubilized protein rich stream is separated using, in one embodiment, with the separator 106 being a disk-stack centrifuge to remove cream fraction. The centrifuge output includes a concentrated oil cream and a de-oiled solubilized protein rich stream. The concentrated oil cream may be discarded or otherwise processed.

In one embodiment, separator 110, wash station 112 and mixer 114 may be omitted from the process flow, whereby the de-oiled protein rich stream can be passed through filters to extract functional proteins. It is recognized that other processing or extraction steps may be utilized aside from the examples noted herein. Wherein, the extracted proteins are then subject to further processing steps described herein.

Whereas, the present processing system therein transfers the de-oiled solubilized protein rich stream to a second mixer 108. An acid is additionally added into the second mixer 108.

Within the second mixer 108, the combination of de-oiled solubilized protein rich stream and the acid generates a protein precipitate. In this second mixer tank 108, acid is added to iso-electrically precipitate the protein. In one embodiment, temperature ranges between 20-75 C depending on the yield of protein extracted in the separation step using the first separator. The lower the temperature, the more native the protein will stay and the higher acid soluble loss. At high temps, higher yields and loss of some functionality will occur. One embodiment provides for pH level to be between 4.0-4.8 depending on temperature profile. Within the second mixer 108, in this embodiment, agitation level is low to promote flocculation. The acid type can be dependent on equipment and desired end functionality of protein.

The combination in the second mixer 108 generates the protein precipitate composed of a serum and an acid curd. The protein precipitate is provided to a third separator 110. In one embodiment, the protein precipitate is fed by a low-shear pump to the third separator 110, being a decanter centrifuge, to separate the serum from the acid curd. The serum protein is extracted, leaving a first protein curd transferred to the wash station 112.

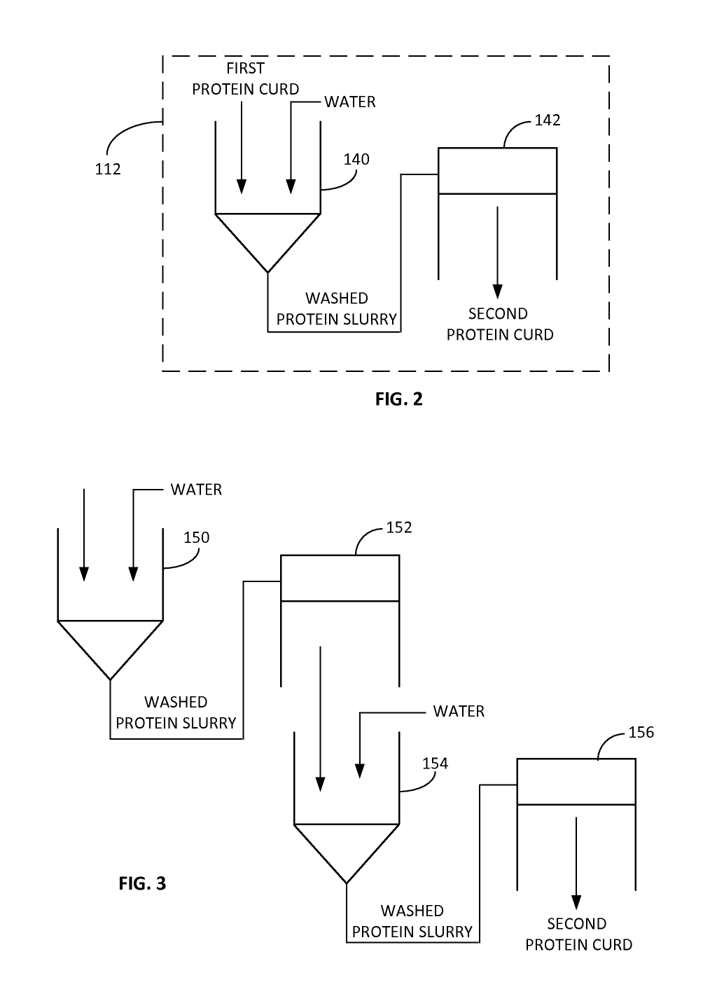

Within the wash station 112, water is added to acid curd to rehydrate the mixture. The water is added via a water mixer to generate acid curd slurry. The wash station further includes wash separator that is, in one embodiment, fed by low-shear pump to the decanter centrifuge to separate the serum from the acid curd. The wash separator therein generates a second protein curd. Further embodiments of the wash station are described relative to FIGS. 2-3 below.

Once the process completes one or more washing operations, a third mixer 114 receives the protein curd output, as well as a base, water and an enzymatic cocktail (protease). In one embodiment, within the mixer 114, the protein curd is hydrated between 90 and 70% moisture. The protein curd is step-wise neutralized to a final pH of 6.5-7.5. Varying step-wise pH adjustments, temperature, and hold times for the mixer are specific to optimal enzymatic reactivity.

In one embodiment, for desired native proteins in the final product, the enzymes are not added.

The third mixer 114 output is a neutral hydrolyzed protein slurry. A high pressure homogenizer 116 receives the slurry such that high pressure homogenization provides for texture, particle size control, and homogenization of the slurry.

The high pressure homogenizer 116 generates an output of a homogenized protein slurry. This homogenized protein slurry is then pasteurized using the pasteurizer 118. In one embodiment, the pasteurizer performs pasteurization at a minimum temperature of 60 C, having a hold time that is dependent on pasteurizing temperature.

The pasteurization, via the pasteurizer 118, generates a pasteurized protein slurry. This slurry is fed into the vacuum evaporator 120. In one embodiment, the vacuum evaporator's pressure, temperature and flow rate are dependent on the pasteurization setup of the pasteurizer. For example, in one embodiment having a high temperature (e.g., 240 F), the vacuum evaporator may include a 2 second hold time with direct steam injection at a −0.5 bar pressure, with a 20 second hold time w/deltaT to 130 degrees at half bar.

Water is removed using the vacuum evaporator 120, producing an output of a cooled protein slurry. The vacuum evaporator 120 can operate in various embodiments based on the desired properties of the cooled protein slurry. For example, one embodiment may include higher order processing operations to remove aromatics attendant in the pasteurized protein slurry. In this example, if the final protein concentrate is usable for food supplements having taste parameters, the removal of the aromatics, also referred to as the volatiles, helps eliminate any subsequent aftertaste from the protein consumption. In other embodiments where the protein supplement may undergo further processing or combined in a manner where aromatics are not problematic, a less efficient operation of the vacuum evaporator 120.

In one embodiment the cooled protein slurry may include volatile elements based on the vacuum evaporation process not removing native aromatics. In another embodiment, the cooled protein may not include these volatile elements, as the elements are removed in the vacuum evaporation process.

The cooled protein slurry is fed into the drier 122. The drier 122 performs drying operations to generate a dried protein concentrate. Different embodiments of drier types and feed temperatures are dependent on one or more factors, including: pasteurization operations; evaporator conditions; hydration level of neutralized protein slurry; and characteristics necessary to consumer application i.e bulk density, moisture level, particle size, and agglomeration.

Therein, the drier 122 generates the dried protein concentrate originated from the flour, water and base originated in the first mixer 102.

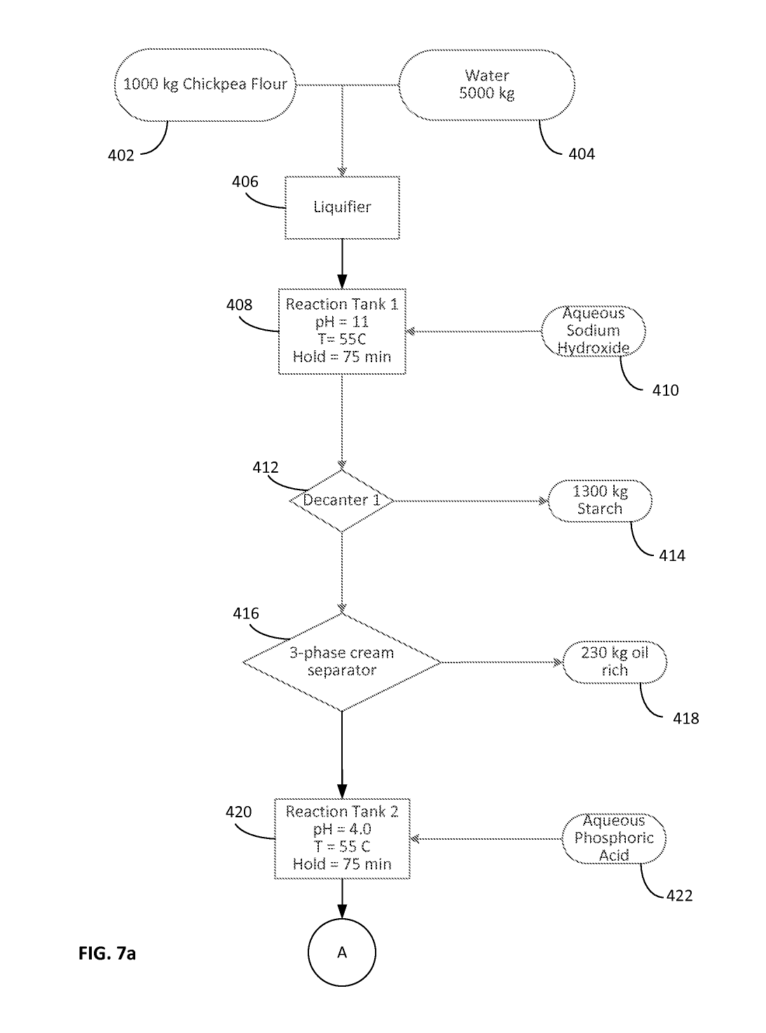

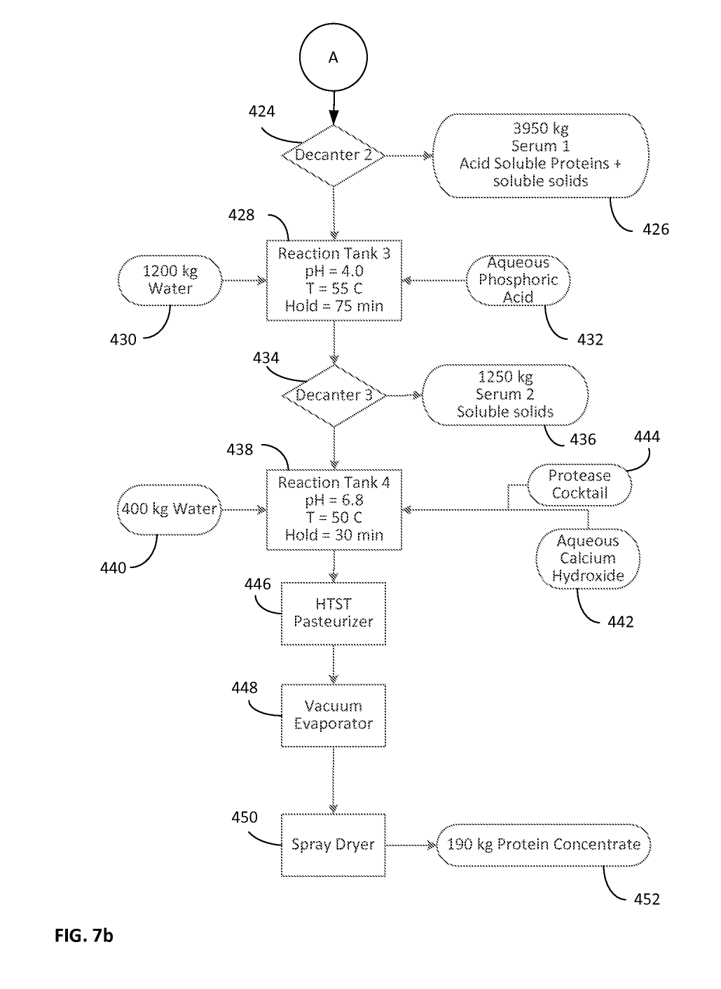

As described in further detail below, FIGS. 7a and 7b illustrate one specific exemplary embodiment of chickpea protein generation using noted operational values.

FIG. 2 illustrates one embodiment of wash station 112 of FIG. 1. In this embodiment, the wash station 112 includes a wash mixer 140 and a wash separator 142. Within the wash station, water is added to acid curd to rehydrate the mixture. The water is added via the water mixer 142 to generate the acid curd slurry. In one embodiment, slurry moisture can range from 98-75% depending on equipment and purity of final product and pH can range between 4.0 and 4.8 depending on temperature profile. In one embodiment, the temperature can range between 20-75 C depending on previous precipitation condition, desired degree of denaturation, yield, and desired purity of the protein concentrate. In the water mixer 140, agitation is low to further promote flocculation.

The wash station 112 further includes the wash separator 142 that is, in one embodiment, fed by low-shear pump to the decanter centrifuge to separate the serum from the acid curd. The wash separator therein generates the second protein curd.

In different embodiments, the operations of the wash station may be iterated for further purity of the protein curd. For example, one technique may include a second wash station with the protein curd rehydrated and then fed by low-shear pump to another decanter centrifuge to further separate serum.

FIG. 3 illustrates one embodiment of a wash station have multiple wash mixers 150, 154 and multiple wash separators 152, 156. As illustrated, the output of the first wash separator 152 is fed directly into a second wash mixer 154. The second wash mixer combines the separator 152 output with water, generating the washed protein slurry. This slurry is fed into the second wash separator 156 to generate the second protein curd.

FIG. 2 illustrates the wash station 112 having a single mixing/separating stage, whereas FIG. 3 illustrates multiple mixing/separating stages. It is recognized that the wash station 112 may include any number of mixing and separating stages, providing higher degree of second protein slurry clarity consistent with operational guidelines, operational efficiency and desired quality of the protein concentrate extracted from the drier 122 of FIG. 1.

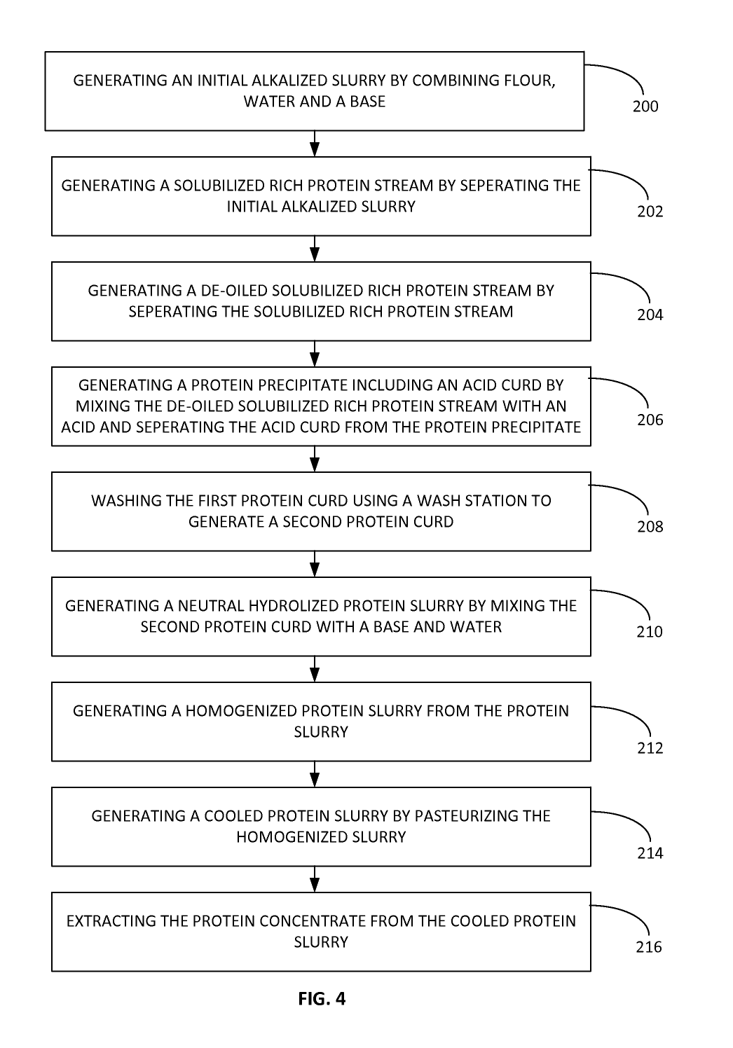

FIG. 4 illustrates one embodiment of a flowchart of steps of a method for generating a chickpea concentrate. The method described herein may be performed using the system 100 of FIG. 1, whereas it is recognized that the steps may be performed using any other suitable machine or apparatus for performing the described operation.

A first step, step 200, is generating an initial alkalized slurry by combining flour, water and base. As described above, the flour is a chickpea based flour.

In one embodiment, instead of chickpea flow feed stock, wet-milled while chickpeas can be used and fed directly to the wet process. In another embodiment, an air classified protein concentrate can be used. It is recognized that various other embodiments exist such that based on preceding processing conditions, a chickpea flour-type input in some manner or another, is fed into the system.

A next step, step 202, is generating a solubilized rich protein stream by separating the initial alkalized slurry. This step may be performed using a separator, wherein in one embodiment the step includes the removal of a starch precipitate from the slurry.

A next step, 204, is generating a de-oiled solubilized rich protein stream by separating the solubilized rich protein stream. This step may be performing using a separator, including generating a concentrated oil cream as well as the de-oiled solubilized rich protein stream.

A next step, step 206, generating a protein precipitate including an acid curd by mixing the de-oiled solubilized rich protein stream with an acid and separating the acid curd from the protein precipitate. This step may be performed using the second mixer 108 as described above.

A next step, step 208, is washing the first protein curd using a wash station to generate a second protein curd. As described in further detail below, this step may include iterative washing operations, generating the second protein curd.

A next step, step 210, is generating a neutral hydrolyzed protein slurry by mixing the second protein curd with a base and water. This step may be performed using the third mixer of FIG. 1 above.

A next step, step 212, is generating a homogenized protein slurry from the protein slurry. The homogenization may be performed using a high pressure homogenizer as described above.

Therefrom, step 214, is generating a cooled protein slurry by pasteurizing the homogenized slurry. The protein slurry may be cooled using a vacuum evaporator, similar to the evaporator 120 of FIG. 1 with operations conditions as described above.

In various embodiments, the cooling of the protein slurry can be performed to varying degrees generating varying quality levels of cooled protein slurry. Using a higher order of evaporating, undesired aromatics may be extracted from the protein slurry.

Step 216 is extracting the protein concentrate from the cooled protein slurry. This step may be performed using a drier performing drying operations, extracting water as the byproduct of the drying process. Therein, in this embodiment, the method provides the extracting of protein concentrate from chickpea flour.

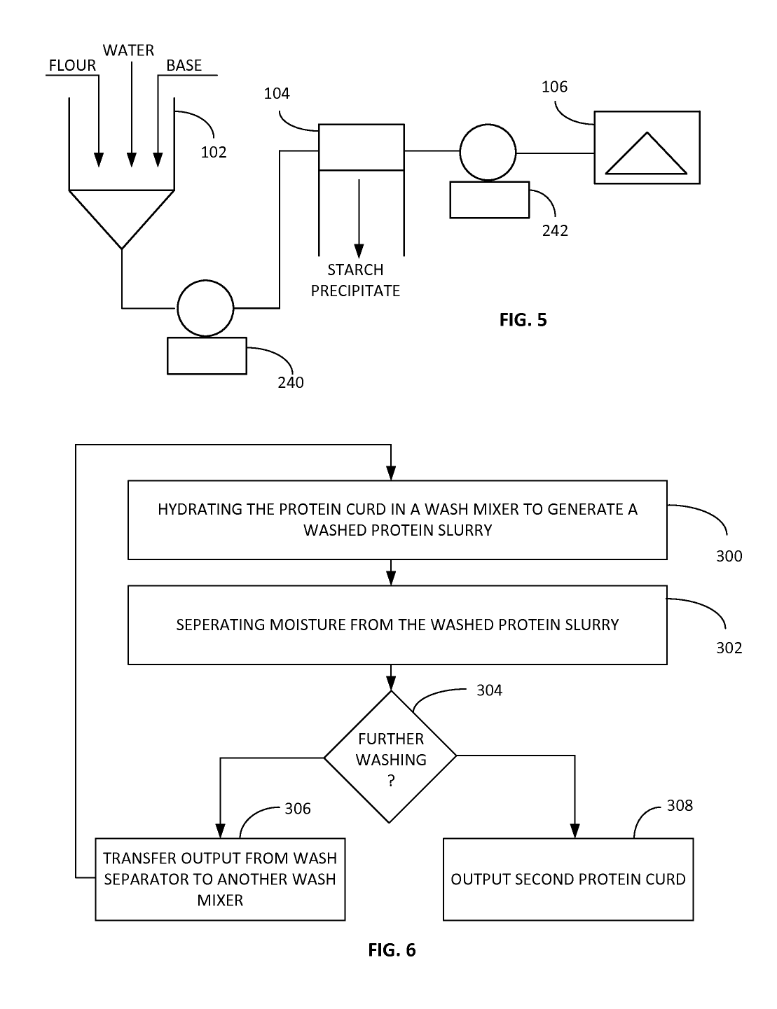

FIG. 5 illustrates one embodiment of a portion of the system of FIG. 1. The illustrated embodiment of FIG. 5 includes the first mixer 102, the first separator 104 and the second separator 106. Whereas, in this embodiment, the outputs from the first mixer 102 is transferred to the first separator using a low sheer pump 240. Similarly, the output of the first separator 104 is transferred to the second separator 106 using a low sheer pump 242. In one embodiment, a positive displacement pump can be used to achieve low shear conditions. An example of this pump is the Waukesha Universal II Pump, Model 130-U2 available from Waukesha Cherry-Burrell in Delavan Wis.

FIG. 6 illustrates a flowchart of one embodiment of further operations of the wash step 208 of FIG. 4. The steps of FIG. 6 may be performed using the elements of FIG. 2 or FIG. 3 described above.

A first step, step 300, is hydrating the protein curd in a wash mixer to generate a washed protein slurry. A next step, step 302, is separating the moisture from the washed protein slurry. In the methodology of FIG. 6, a determination is made if there are further washing iterations, step 304.

In the event further washings are requested or required, step 306 is transferring the output of the wash mixer from the wash separator into another wash mixer. Thereupon, the method re-iterates to step 300. In the event the determination of step 304 is that no further washing is requested or required, the method reverts to step 308, outputting the second protein curd. Therefore, the methodology allows for the iterative washing of the protein curd, if desired.

FIGS. 7a and 7b illustrate a processing flowchart of one exemplary embodiment of a chickpea protein extraction process. While noted with exemplary values, the embodiment of FIGS. 7a and 7b, including the exemplary values, are not limiting in nature as varying processing values may be readily utilized, as recognized by one skilled in the art.

The process begins in FIG. 7a, wherein 1000 kg Chickpea flour 402 is liquefied with 5000 kg water 404 using a liquefier 406. The combined slurry enters a first reaction tank 408 in which the pH is adjusted to 11 using aqueous sodium hydroxide 410, temperature at 55 C and held under low shear conditions for approximately 75 minutes. Using the first decanter 412, approximately 1300 kg of wet starch 414 is then extracted and the protein rich liquid is passed through a 3-phase cream separator 416. This cream separator extracts approximately 230 kg of concentrated oil 418.

The de-oiled protein stream from the 3-phase cream separator 416 then passes into a second reaction tank 420, in which the pH is adjusted to 4.0 using aqueous phosphoric acid 422, temperature at 55 C, and held approximately 75 minutes. From the second decanter 420, 3950 kg aqueous sugars and acid soluble proteins 426 are removed to the light phase. From the second decanter 420, the protein curd is then provided to a third reaction tank 420, rehydrated to 10% dry solids with 1200 kg water 430 at 55 C. If necessary, the pH is adjusted back to 4.0 using aqueous phosphoric acid 432 and held for approximately 75 minutes.

The rehydrated protein rich slurry is then passed through a third decanter 434, removing approximately 1250 kg of serum 2 consisting of primarily aqueous sugars 436. A fourth reaction tank 438 receives the second acid curd from the third decanter 434, combines with 400 kg of water at 50 C 440, to achieve a 15% dry solid mixture. The pH is adjusted to approximately 6.8 using calcium hydroxide 442 and then a protease cocktail 444 is added to cleave the proteins for end application.

In this embodiment, the enzymatic reaction is allowed to take place for approximately 30 min under low shear conditions and fed to a High Temperature/Short Time pasteurizer 446 to kill any microbial and terminate the enzymatic reaction.

The slurry is then fed to a vacuum evaporator 448 to increase the solids level. The output of the evaporator 448 is then spray dried using spray dryer 450. Wherein, in this embodiment, the process obtains 190 kg of a hydrolyzed protein concentrate 452 at minimum 80% protein.

It is recognized that varying the processing conditions noted above adjusts the output volume and concentrate levels. Whereas within the scope of the present invention, reducing processing time or reducing ingredient combinations may generate reduced concentration levels acceptable for varying industrial or commercial uses. Similarly, refinements may include increased quality or other attributes of the protein concentrate, such as digestibility, after taste/aromatics, consistency, mouth-feel, by way of example. As such, the varying operational variations are within the scope of the present invention and the noted example and ranges above are exemplary and not limiting in their disclosure.

In addition the method and system described herein, the present method and system additionally allows a chickpea concentrate made by the process described herein. The chickpea concentrate is made, in various embodiments, using the above described methods and systems.

Therefore, the present method, system and chickpea concentrate overcomes the limitations of the prior art by allow for the utilization of chickpea as a vital protein source. The method and system incorporate varying operational guidelines, such as acidity levels, processing times, flow rates, temperature ranges, to generate the herein described chickpea concentrate.

FIGS. 1 through 7 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

1. A method for generating a protein concentrate, the method comprising:
generating an initial alkalized slurry by combining flour, water and a base;
generating a solubilized rich protein stream by separating the initial alkalized slurry;
generating a de-oiled solubilized rich protein stream by separating the solubilized protein rich stream;
generating a protein precipitate including an acid curd by mixing the de-oiled solubilized rich protein stream with an acid and separating the acid curd from the protein precipitate;
washing the first protein curd using a wash station to generate a second protein curd;
generating a neutral hydrolyzed protein slurry by mixing the second protein curd with a base and water;
generating a homogenized protein slurry from the protein slurry;
generating a cooled protein slurry by pasteurizing the homogenized protein slurry; and
extracting the protein concentrate from the cooled protein slurry.

2. The method of claim 1 further comprising:
separating the solubilized rich protein stream and a starch precipitate from the initial alkalized slurry

3. The method of claim 1 wherein the separation of the initial alkalized slurry is performed using a decanter centrifuge.

4. The method of claim 1 further comprising:
using a low-sheer pump to transport at least one of: the initial alkalized slurry and the solubilized protein rich stream.

5. The method of claim 1 further comprising:
separating the solubilized protein rich stream using a disk-stack centrifuge; and
removing a cream fraction from the solubilized protein rich stream.

6. The method of claim 1, wherein the protein precipitate includes the acid curd and a serum, the method further comprising:
separating the serum from the protein precipitate using a low-shear pump and a decanter centrifuge; and
extracting the serum protein.

7. The method of claim 1, wherein the washing the first protein curd further comprises:
hydrating the first protein curd in a wash mixer to generate a washed protein slurry; and
separating moisture from the washed protein slurry to generate the second protein curd.

8. The method of claim 7 further comprising:
passing the first protein curd through multiple washing operations prior to outputting the second protein curd.

9. The method of claim 1, wherein the mixing the second protein curd with a base and water further includes mixing a protease solution.

10. The method of claim 1 further comprising:
using a high pressure homogenizer to generate the homogenized protein slurry.

11. The method of claim 1, wherein extracting the protein concentrate from the cooled protein slurry further comprises:
drying the cooled protein slurry.

12. The method of claim 1, wherein the flour includes chickpea flour.

13. A system for generating a protein concentrate comprising:
a first mixer generating an initial alkalized slurry by combining flour, water and a base;
a first separator generating a solubilized rich protein stream by separating the initial alkalized slurry;
a second separator generating a de-oiled solubilized rich protein stream by separating the solubilized protein rich stream;
a second mixer generating a protein precipitate including an acid curd by mixing the de-oiled solubilized rich protein stream with an acid;
a third separator separating the acid curd from the protein precipitate;
a washing station operative to wash the first protein curd and generate a second protein curd;
a third mixer generating a neutral hydrolyzed protein slurry by mixing the second protein curd with a base and water;
a homogenizer generating a homogenized protein slurry by homogenizing the protein slurry;
a pasteurizer generating a cooled protein slurry by pasteurizing the homogenized protein slurry; and
an extractor for extracting the protein concentrate from the cooled protein slurry.

14. The apparatus of claim 13, wherein the first separator separates a starch precipitate from the initial alkalized slurry

15. The apparatus of claim 13, wherein the first separator is a decanter centrifuge.

16. The apparatus of claim 13 further comprising:
a low-sheer pump operative to transport at least one of: the initial alkalized slurry and the solubilized protein rich stream.

17. The apparatus of claim 13, wherein the second separator is a disk-stack centrifuge operative to remove a cream fraction from the solubilized protein rich stream.

18. The apparatus of claim 13, wherein the protein precipitate includes the acid curd and a serum, the apparatus further comprising:
the third separator is a decanter centrifuge using a low-shear pump, the third separator separating the serum protein.

19. The apparatus of claim 13, wherein the washing station comprises:
a wash mixer to generate a washed protein slurry; and
a wash separator for separating moisture from the washed protein slurry to generate the second protein curd.

20. The apparatus of claim 13, wherein the mixing the second protein curd with a base and water further includes mixing a protease solution.

21. The apparatus of claim 13, wherein the homogenizer is a high pressure homogenizer.

22. The apparatus of claim 13 further comprising:
a drier for drying the cooled protein slurry and extracting the protein concentrate therefrom.

23. The apparatus of claim 13, wherein the flour includes chickpea flour.

24. A chickpea concentrate made by a process comprising:
generating an initial alkalized slurry by combining flour, water and a base;
generating a solubilized rich protein stream by separating the initial alkalized slurry;
generating a de-oiled solubilized rich protein stream by separating the solubilized protein rich stream;
generating a protein precipitate including an acid curd by mixing the de-oiled solubilized rich protein stream with an acid and separating the acid curd from the protein precipitate;
washing the first protein curd using a wash station to generate a second protein curd;
generating a neutral hydrolyzed protein slurry by mixing the second protein curd with a base and water;
generating a homogenized protein slurry from the protein slurry;
generating a cooled protein slurry by pasteurizing the homogenized protein slurry; and
extracting the protein concentrate from the cooled protein slurry.
